(19) United States
(12) Patent Application Publication
(10) Pub. No.: US 2022/0234882 A1
(43) Pub. Date: Jul. 28, 2022

(54) SADDLE TREE FOR A RIDING SADDLE, AND RIDING SADDLE

(71) Applicant: Euroriding GmbH & Co KG, Heede (DE)

(72) Inventor: Carsten Engelke, Lindwedel (DE)

(21) Appl. No.: 17/606,591

(22) PCT Filed: Apr. 30, 2020
(86) PCT No.: PCT/EP2020/062136

§ 371 Date: Oct. 26, 2021

(30) Foreign Application Priority Data
Apr. 30, 2019 (EP) 19171962.4

(51) Int. Cl. B68C 1/04

(52) U.S. Cl. CPC B68C 1/04; B68C 2001/042

(57) ABSTRACT

The invention relates to a saddle tree for a riding saddle and to a riding saddle having such a saddle tree. The saddle tree according to the invention comprises a saddle tree structure extending in the longitudinal direction from a pommel to a cantle, the upper side of the saddle tree structure forming a seat for a rider and the seat defining a contact area for the rider's sit bones. In the area between the contact area for the sit bones and the cantle, the saddle tree structure has a pivot axis transverse to the longitudinal direction, about which the cantle, starting from a zero position with respect to the pommel specified by a stop, can pivot towards the upper side. The riding saddle according to the invention is based on saddle tree of this kind.

### BACKGROUND

The invention relates to a saddle tree for a riding saddle and to a riding saddle having a corresponding saddle tree.

The prior art discloses riding saddles which are created, in particular, for traditional riding instruction and build on a saddle tree. The rigid saddle tree here is formed such that it has its underside, with saddle pads arranged thereon, basically adapted to horses' backs in order to keep, in particular, pressure from acting directly on the spine of the horses and to distribute it over as large a surface area as possible. A seat for the rider is formed on the upper side, this seat allowing the rider to sit in a stable, upright manner.

In particular in the case of short-backed horses, there is the problem that the rear part of classic saddles frequently projects into the lumbar region of the horses and thus restricts the movement capability of the horses. This can result in the horses having orthopedic problems and/or in some cases dangerous defensive reactions, such as bucking or rearing, occurring.

For such cases, it is known to arrange shortened panels or French saddle panels among classic saddle trees, so that the panels do not rest on the lumbar region of the horses, even if the saddle tree projects into this region. The disadvantage here is that the loading caused by the rider is not introduced uniformly into the backs of the horses and pressure peaks occur in particular in the rear region of the panels. Moreover, the rear region of the saddle tree, which is not supported directly by a panel, gives rise to a rocker effect (also referred to as a trampoline effect), which results in the saddle and the rider being extremely unstable, which in turn creates additional loading for the horse.

Treeless saddles massively inhibit the rider's influence. Moreover, loading which is introduced at certain points, for example via the stirrups, cannot be distributed effectively over the length of the saddle, and this also results in considerable pressure peaks.

This problem is basically also found in flexible saddle trees (so-called flex trees) which are known from the prior art and in which the saddle tree is subdivided into a plurality of segments which are freely movable in relation to one another, wherein loading which is introduced into a certain segment, for example via the stirrups, is frequently not distributed effectively over the length of the saddle.

In particular saddles which have known flex trees also have the disadvantage that they do not give the rider the impression of being seated in a stable manner, and therefore the rider frequently does not, or cannot, assume the correct riding posture.

### SUMMARY OF THE INVENTION

It is the object of the present invention to create a saddle tree for riding saddles, and also a riding saddle, in the case of which the disadvantages which are known from the prior art occur only to a reduced extent or not at all.

This object is achieved by a saddle tree as claimed in the main claim and by a riding saddle as claimed in claim 8. Advantageous developments form the subject matter of the dependent claims.

Accordingly, the invention relates to a saddle tree for a riding saddle, having a saddle-tree structure which extends in the longitudinal direction from a pommel to a cantle and the upper side of which forms a seat for a rider, wherein the seat defines a contact region for the sit bones, and, in the region between the cantle and the contact region for the sit bones, the saddle-tree structure has a pivot axis which is oriented transversely in relation to the longitudinal direction and about which, starting from a zero position predetermined by a stop, the cantle can be pivoted in the direction of the upper side in relation to the pommel.

The invention also relates to a riding saddle comprising a saddle tree according to the invention.

First of all, an explanation will be given of some of the terms used in conjunction with the invention.

“The pommel and cantle” of a saddle tree extend transversely in relation to the longitudinal direction of the saddle and serve, in the use state of the saddle which is built on the saddle-tree structure, to keep loading away from the horse's spine in that the saddle rests on the horse's back on both sides of the spine, but not directly in the region of the spine. In the use state of the saddle, the pommel here forms the region which is directed toward the horse's head, whereas the cantle is arranged in the vicinity of, or in, the horse's lumbar region. The pommel and cantle can be connected to one another via bars which, in the use state of the saddle, run on both sides of the spine. However, it is also possible for the pommel and cantle to be formed in one piece in a continuous plastic shell.

The upper side of the saddle tree and the structure of the latter basically form the seat for the rider using the saddle which is built on the saddle tree. It is therefore the saddle tree alone which predetermines the correct sitting position for a rider, this sitting position also directly dictating the position of the rider's legs. It is therefore readily possible to determine that region on the saddle tree against which the rider's legs will rest, on the basis of the saddle tree, when the saddle is subsequently in the finished state. This region is referred to as the “contact region for the sit bones”. It is in this region of the subsequently finished saddle that the “saddle flaps” are usually fastened, the saddle flaps protecting the horse's coat against the rider's legs.

The invention has recognized that providing a certain pivoting capability for the rear part of the saddle tree in relation to the front part thereof can result in a horse's lumbar region being relieved of loading to a considerable extent without other points of the horse's back being subjected to undesired high pressure peaks. In addition, the support provided for the rider is not compromised, or at least not critically.

In order to achieve this, according to the invention, the rear part of the saddle tree can be pivoted upwards, starting from a zero position, about a pivot axis which runs, transversely in relation to the longitudinal direction of the saddle, between the cantle and the contact region for the sit bones, whereas pivoting in the other direction beyond the zero position is prevented by the stop which defines the zero position.

The zero position here can be selected, in particular, such that, in this zero position, the saddle tree according to the invention essentially assumes a shape as is known, in principle, from traditional riding saddles. If a rider is sitting directly on the seat formed by the saddle tree, the saddle tree of the rider is usually inevitably in the zero position, since the rear part is pivoted as far as the stop, and therefore into the zero position, on account of the rider's weight. The rider's weight can then be introduced into the horse's back, with distribution over the entire length of the saddle tree, without undesired pressure peaks occurring.

At the same time, when the actual seat is at least briefly relieved of loading by the rider on account of riding movements, the rear part of the saddle tree, and therefore of the saddle, can pivot upwards, whereby the horse's movement capability in the lumbar region is significantly increased at these times in comparison with a classic saddle with a rigid saddle tree.

It is possible to provide a restoring element which, when the cantle is deflected out of a rest position, forces the cantle back into the rest position. The rest position is therefore the position into which the cantle is moved by the restoring element when there are no external forces—such as, for example, the rider's weight—acting on the saddle tree and/or the saddle which is built thereon.

It is possible, in principle, for the rest position to correspond to the zero position. In this case, the movements in the horse's lumbar region can move the cantle out of the rest position when the rider is not sitting directly on the seat, whereby the horse's movement capability is significantly increased in relation to a saddle with a traditional saddle tree.

However, it is particularly preferred if the rest position is different from the zero position. In this case, the cantle normally does not rest on the horse's back; rather, the cantle is pivoted into the zero position only when a rider is sitting, and putting his weight, on the seat formed by the saddle tree. In this case, the rider's weight is introduced into the horse's back with distribution over the entire saddle tree. For the rest, the horse's lumbar region remains free of loading from the saddle tree, and this therefore ensures a high level of movement capability for the horse in this region.

The restoring element can preferably comprise at least one rod-like or sheet-like bending spring, which extends beyond the pivot axis. The rest position can be straightforwardly defined by the starting shape of the bending spring and the way in which the latter is attached to the saddle-tree structure. In particular in the case of a plurality of bending springs being arranged parallel to one another, there is usually no need for any additional articulation elements, or any other kind of pivoting element, along the pivot axis. In this case, the simplicity of the design and of the bending springs themselves results in the saddle tree being practically maintenance-free.

It is preferred if the stop is fixed on the saddle-tree structure on one side of the pivot axis and extends beyond the pivot axis to form a stop surface. This configuration of the stop at least partially covers the region of the pivot axis on the underside of the saddle tree, and therefore for example the horse-protecting covers which are often arranged in this region cannot get into the direct pivoting region of the saddle tree and restrict, or completely block, the pivoting movement which is envisaged according to the invention. It is particularly preferred here if the stop extends over the entire width of the saddle tree in the region of the pivot axis, that is to say if it completely covers the region of the pivot axis.

The saddle-tree structure can be produced from wood or plastic.

As far as the explanation of the riding saddle according to the invention is concerned, reference is made to what has been said above.

### BRIEF DESCRIPTION OF THE DRAWINGS

The invention will now be described further by way of example on the basis of an advantageous embodiment and with reference to the attached drawings, in which:

FIG. 1: shows a schematic illustration of a first exemplary embodiment of a saddle tree according to the invention;

FIG. 2: shows a plan view of the saddle tree from FIG. 1;

FIGS. 3a and b: show sectional views of the saddle tree from FIGS. 1 and 2, taken along the longitudinal direction from FIG. 2, in the zero position and rest position of the cantle; and

FIGS. 4a and b: show a riding saddle which is built on the saddle tree according to FIGS. 1 to 3, the riding saddle having the cantle in the zero position and rest position.

### DETAILED DESCRIPTION

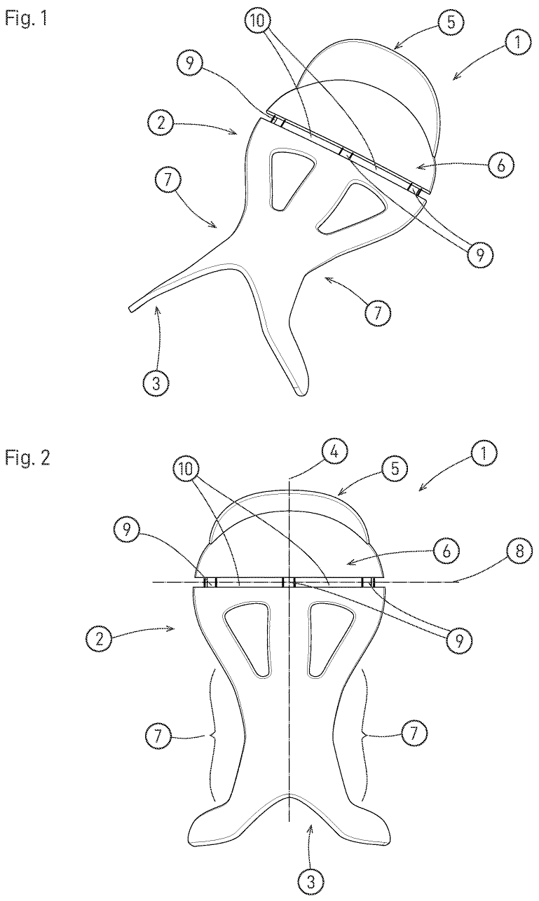

FIGS. 1 and 2 show a saddle tree 1 according to the invention. The saddle tree 1 comprises a saddle-tree structure 2, which is manufactured from plastic and extends along a longitudinal direction 4 from a pommel 3 to a cantle 5. The saddle-tree structure 2 forms a seat 6 for the rider, this seat also being replicated in a saddle which is built on the saddle-tree structure 2 illustrated. The shaping of the seat 6 gives rise to contact regions 7, which are arranged directly on both sides of the saddle-tree structure 2 and at which, when a rider is seated correctly, the rider's legs rest against the saddle-tree structure 2 and/or the saddle which is built thereon.

The saddle-tree structure 2 is interrupted between the contact region 7 and the cantle 5—and therefore in the region of the seat 6—in order to form a pivot axis 8, which runs perpendicularly in relation to the longitudinal direction 4 of the saddle-tree structure 2. Three sheet-like bending springs 9 extend over the region of the pivot axis 8 and are connected to the saddle-tree structure 2 on both sides, said bending springs, in the form of restoring elements, making it possible for the cantle 5 to pivot in relation to the front part of the saddle-tree structure 2 without any further articulations or the like being required along the pivot axis 8 for this purpose.

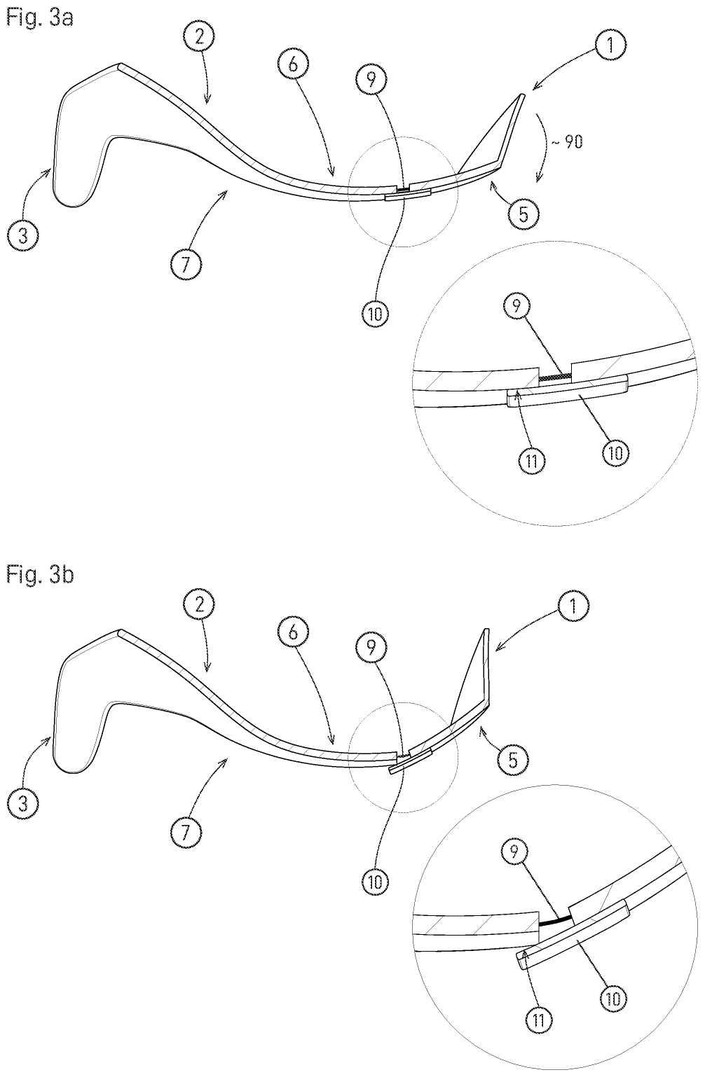

It is also the case that a stop 10 is provided over the entire width of the saddle-tree structure 2, in the region of the pivot axis 8, and the precise configuration and functioning of this stop will be explained hereinbelow with reference to FIGS. 3a and 3b.

FIGS. 3a and 3b each illustrate the saddle tree 1 according to FIGS. 1 and 2 in a sectional illustration taken along the longitudinal direction 4 of the saddle-tree structure 2 (cf. FIG. 2), FIG. 3a showing the saddle-tree structure 2 and/or the cantle 5 in the zero position, whereas FIG. 3b illustrates the saddle-tree structure 2 in the rest position. Each of the figures are supplemented by a detail-specific illustration of the region around the pivot axis 8.

The stop 10 is fixed on the saddle-tree structure 2, along the pivot axis 8, on the side of the cantle 5 and projects all the way over the region of the pivot axis 8, and therefore, by way of the stop region 11 indicated by the reference sign 11, the stop 10 abuts against the saddle-tree structure 2, on the opposite side of the pivot axis 8, such that pivoting of the cantle 5 in the direction which is indicated by the arrow 90 in FIG. 3a is prevented. The position which is shown in FIG. 3a is therefore clearly defined by the stop 10 and is referred to as the zero position.

The zero position is reached whenever a rider is sitting in the seat 6 formed by the saddle-tree structure 2, with his weight thereon.

The absence of any weight acting on the seat 6 results in the rest position, which is shown in FIG. 3b and in which the cantle 5 has been pivoted upward in relation to the zero position from FIG. 3a. The rest position is assumed automatically, since the bending springs 9 are correspondingly pre-formed as restoring elements and are arranged on the saddle-tree structure 2 that the rest position of the cantle 5 which is shown corresponds to the rest position of the bending springs 9. Starting from the rest position, the cantle 5 can be pivoted into the zero position according to FIG. 3a counter to the restoring forces generated by the bending springs 9. However, it is also possible, in principle, for the cantle 5 to be pivoted further upward.

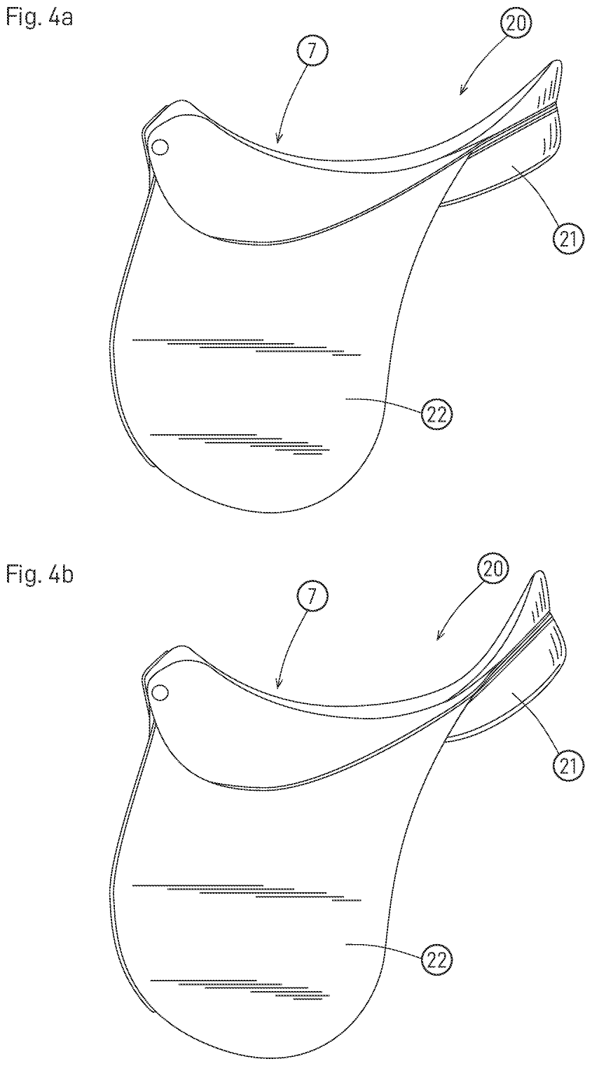

FIGS. 4a and 4b show, in a manner analogous to FIGS. 3a and 3b, a riding saddle 20 which is built on the saddle tree 1 described. The saddle tree 1 here is arranged in the interior of the leather riding saddle 20 and, on its underside, has saddle pads 21 for resting on a horse's back. The saddle pads 21 here extend over the entire length of the riding saddle 20 and therefore also over the region of the pivot axis 8 of the saddle tree 1.

A respective saddle flap 22 is provided on both sides of the saddle 20 in the contact region 7 for the legs of a rider which is sitting in the seat of the saddle 20.

The riding saddle 20 is designed such that the saddle tree 1 can assume the positions—zero position (FIG. 4a) and rest position (FIG. 4b)—explained in conjunction with FIGS. 3a and 3b. In particular, the saddle 20 is therefore of such flexible configuration in the region of the pivot axis 8 of the saddle tree 1 that the pivoting capability which is envisaged according to the invention is still ensured.

1. A saddle tree for a riding saddle, having a saddle-tree structure which extends in the longitudinal direction from a pommel to a cantle and the upper side of which forms a seat for a rider, wherein the seat defines a contact region for the sit bones, wherein, in a region between the cantle and a contact region for the sit bones, the saddle-tree structure has a pivot axis which is oriented transversely in relation to the longitudinal direction and about which, starting from a zero position predetermined by a stop, the cantle can be pivoted in the direction of the upper side in relation to the pommel.

2. The saddle tree of claim 1, comprising a restoring element which, when the cantle is deflected about the pivot axis out of a rest position, forces the cantle back into the rest position.

3. The saddle tree of claim 2, wherein the rest position is different from the zero position.

4. The saddle tree of claim 2, wherein the restoring element comprises at least one rod-like or sheet-like bending spring, which extends beyond the pivot axis.

5. The saddle tree of claim 1, wherein the stop is fixed on the saddle-tree structure on one side of the pivot axis and extends beyond the pivot axis to form a stop surface.

6. The saddle tree of claim 5, wherein the stop extends over the entire width of the saddle-tree structure in the region of the pivot axis.

7. The saddle tree of claim 1, wherein the saddle-tree structure is made of wood or plastic.

8. A riding saddle comprising a saddle tree, wherein the saddle tree is designed in accordance with claim 1.

9. The riding saddle of claim 8, comprising a saddle pad on the underside of the saddle tree, wherein the saddle pad which extends beyond the pivot axis.

10. The riding saddle of claim 8, wherein a saddle flap is provided at the contact region for the sit bones, on either side of the longitudinal direction.
